(19) United States
(12) Patent Application Publication
(10) Pub. No.: US 2007/0217073 A1
(43) Pub. Date: Sep. 20, 2007

(54) DISK USABLE WITH HARD DISK DRIVE AND HARD DISK DRIVE HAVING THE SAME

(75) Inventor: Jong-Hak LEE, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/684,684

(22) Filed: Mar. 12, 2007

(30) Foreign Application Priority Data
Mar. 20, 2006 (KR) 2006-25305

(51) Int. Cl. G11B 5/82

(52) U.S. Cl. 360/135

(57) ABSTRACT

A disk usable with a hard disk drive includes a first texture recessively formed in a surface of a substrate of the disk and textured in a first pattern of a first net shape to have a first cross angle where line patterns of the first pattern cross each other, and a second texture formed on the surface of the disk substrate independently of the first texture and textured in a second pattern of a second net shape to have a second cross angle where second line patterns of the second pattern cross each other, the second cross angle being relatively smaller than the first cross angle. The first and second textures of the disk also have first and second surface roughness created by grooves in the first and second patterns. Fly-ability of the magnetic head is improved by an increase in surface roughness or a cross angle at which patterns of a texture cross each other is increased, which decreases excessive absorption and friction generated during disk rotation, and prevents deterioration of the fly-ability of the magnetic head due to low linear velocity. Simultaneously, a bit error rate (BER) can be improved by improving an orientation ratio (OR) that improves a magnetic characteristic of the disk. Thus, the quality of a small form factor (SFF) hard disk drive (HDD) is improved.

### CROSS-REFERENCE TO RELATED APPLICATIONS

This application claims priority under 35 U.S.C. § 119(a) from Korean Patent Application No. 10-2006-0025305, filed on Mar. 20, 2006, in the Korean Intellectual Property Office, the disclosure of which is incorporated herein in its entirety by reference.

### BACKGROUND OF THE INVENTION

1. Field of the Invention

The present general inventive concept relates to a disk usable with a hard disk drive, and more particularly, to a disk usable with a hard disk drive which can improve not only fly-ability of a magnetic head but also an orientation ratio (OR) that enhances a magnetic characteristic of the disk, and a hard disk drive having the same.

2. Description of the Related Art

Hard disk drives (HDDs) formed of electronic parts and mechanical parts are memory devices to record and reproduce data by converting digital electric pulses to a magnetic field that is more permanent. The HDDs are widely used as auxiliary memory devices of computer systems because of fast access time to a large amount of data.

With the recent increase in TPI (track per inch) and BPI (bits per inch) capabilities, the HDD has achieved an increased capacity and its application field has expanded. Accordingly, there has been a request for development of compact HDDs which can be used with portable electronic products such as notebooks (PCs), personal digital assistants (PDAs), and mobile phones. Actually, a small form factor (SFF) HDD having a diameter of 0.85 inches, which has a size similar to a coin, has been recently developed and is expected to be used with mobile phones in the future.

The HDD, as illustrated in FIG. 1, includes a magnetic head 131 flying over a disk 110 that is rotating. The magnetic head 131 is mounted on a slider 136 that is supported by a suspension 134 to be elastically biased toward a surface of the disk 110. In a state when recording and reproduction of data is performed, a lift force due to the rotation of the disk 110 and an elastic force by the suspension 134 act on the slider 136 where the magnetic head 131 is mounted. Accordingly, since the slider 136 maintains a lifted state above a recording surface of the disk 110 at a height where the lift force and the elastic force are balanced, the magnetic head 131 that is mounted on the slider 136 records and reproduces data with respect to the disk 110 while maintaining a distance from the disk 110 that is rotating.

Meanwhile, when power is turned off and the rotation of the disk 110 is stopped, since the lift force that lifts the slider 136 disappears, damage to the recording surface due to the contact by the slider 136 is prevented by allowing the slider 136 to move away from the recording surface of the disk 110 in advance.

However, while the magnetic head 131 floats above the disk 110 and performs the recording and reproduction of data, it is preferable that the magnetic head 131 is maintained as close to the recording surface of the disk 110 as possible. In other words, a flying height of the magnetic head 131 is preferably maintained at its minimum. This is because a width of a recording track of the disk 110 can be reduced by as much as the flying height of the magnetic head 131 decreases. When the recording track width decreases, a storage capacity of the disk 110 can be improved.

Thus, when a surface of the magnetic head 131 and the recording surface of the disk 110 are made more flat, the flying height of the magnetic head 131 can be lowered to an extent corresponding to the flatness of the recording surface and the magnetic head surface. However, when the surface of the magnetic head 131 and the recording surface of the disk 110 are made too flat, a perfect match of the two surfaces generates excessive absorption and friction. Accordingly, the magnetic head 131 and the recording surface of the disk 110 become abraded and then a head crash occurs. Considering this problem, to reduce friction between the magnetic head 131 and the disk 110, the recording surface of the disk 110 is provided with a texture that is a rough surface formed by a technique called texturing.

The surface roughness or pattern of the texture is determined in consideration of various factors such as improvement of storage capacity. In particular, for a disk usable with an SFF HDD having a diameter of not more than 1 inch, for example, 0.7 to 1 inch, even though a diameter of the disk is quite small, since a storage capacity over a predetermined level is required, a texture structure which can secure the storage capacity and improve a bit error rate (BER) needs to be adopted.

For a high storage capacity and the improvement of a BER, a line density on a recording surface needs an improvement so that the width of a track can be decreased. Thus, to satisfy the above conditions, a texture unevenness height is lowered by decreasing surface roughness or by adopting a texture having a small cross angle at which texture patterns cross each other.

However, when the texture unevenness height is lowered or the cross angle of the texture patterns is small, it is difficult to prevent a mechanical interaction such as a friction between the magnetic head and the disk surface. This results in the fly-ability of the magnetic head being deteriorated. The deterioration of fly-ability in the magnetic head becomes a problem to solve, particularly, in an SFF HDD having a diameter of not more than 1 inch and rotating at an R.P.M. of 3,600 through 5,400.

To solve the above problem, there is needed a method of improving the fly-ability of the magnetic head by forming a texture in which the texture unevenness height is increased or the cross angle at which the patterns of the texture cross each other is increased. In this method, however, the OR that improves a magnetic characteristic is deteriorated so that an improvement of the BER cannot be obtained. Thus, a method is also needed which can improve the OR and the fly-ability of the magnetic head and which can minimize various problems related to lubrication that may occur between the head and disk, which become a serious problem, particularly in the SFF HDD.

### SUMMARY OF THE INVENTION

The present general inventive concept provides a disk usable with a hard disk drive which can improve fly-ability of a magnetic head by compensation of the deterioration of the fly-ability of the magnetic head that may occur due to a low linear velocity and which can simultaneously improve a bit error rate (BER) by improving an orientation ratio (OR) that improves a magnetic characteristic of the disk, and a hard disk drive having the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a disk usable with a hard disk drive including a first texture recessively formed in a surface of a substrate of the disk and textured in a pattern of a net shape, and having a first cross angle where the patterns cross each other, and a second texture formed on the surface of the disk substrate independently of the first texture and textured in a pattern of a net shape, and a second cross angle where the patterns cross each other, the second cross angle being relatively smaller than the first cross angle.

The second texture may be textured after the first texture is textured on the disk substrate.

The first texture and the second texture may be textured in a circumferential direction.

The first cross angle may be 10-30° at an inner diameter and the second cross angle may be 0-10° at the inner diameter.

The first texture may have an average surface roughness Ra between 3-10 Å and the second texture may have an average surface roughness Ra between 1-4 Å.

The diameter of the disk may be 0.7-1.0 inch.

The foregoing and/or other aspects of the present general inventive concept may also be achieved by providing a disk including a first texture recessively formed in a surface of a substrate of the disk and textured in a pattern of a net shape to have a first surface roughness, and a second texture formed on the surface of the disk substrate independently of the first texture and textured in a pattern of a net shape to have a second surface roughness that is relatively smaller than the first surface roughness.

The second texture may be textured after the first texture is textured on the disk substrate.

The first texture and the second texture may be textured in a circumferential direction.

The first texture may have an average surface roughness Ra between 3-10 Å and the second texture may have an average surface roughness Ra between 1-4 Å.

The foregoing and/or other aspects of the present general inventive concept may also be achieved by providing a disk usable with a hard disk drive including a base, the disk installed on the base, wherein the disk includes a first texture recessively formed in a surface of a substrate of the disk and textured in a pattern of a net shape, and having a first cross angle where the patterns cross each other, and a second texture formed on the surface of the disk substrate independently of the first texture and textured in a pattern of a net shape, and a second cross angle where the patterns cross each other, the second cross angle being relatively smaller than the first cross angle.

The second texture may be textured after the first texture is textured on the disk substrate.

The first texture and the second texture may be textured in a circumferential direction.

The first cross angle may be 10-30° at an inner diameter and the second cross angle may be 0-10° at the inner diameter.

The first texture may have an average surface roughness Ra between 3-10 Å and the second texture may have an average surface roughness Ra between 1-4 Å.

The diameter of the disk may be 0.7-1.0 inch.

The foregoing and/or other aspects of the present general inventive concept may also be achieved by providing a disk usable with a hard disk drive including a base and a disk installed on the base, wherein the disk includes a first texture recessively formed in a surface of a substrate of the disk and textured in a pattern of a net shape to have a first surface roughness, and a second texture formed on the surface of the disk substrate independently of the first texture and textured in a pattern of a net shape to have a second surface roughness that is relatively smaller than the first surface roughness.

The second texture may be textured after the first texture is textured on the disk substrate.

The first texture and the second texture may be textured in a circumferential direction.

The first texture may have an average surface roughness Ra between 3-10 Å and the second texture may have an average surface roughness Ra between 1-4 Å.

The foregoing and/or other aspects of the present general inventive concept may also be achieved by providing a disk usable with a hard disk drive including first patterns formed therein along a surface of the disk, and second patterns formed thereon along the surface of the disk different from the first patterns.

The foregoing and/or other aspects of the present general inventive concept may also be achieved by providing a method of texturing a recordable medium formed of a substrate, the method including forming a first texture in the substrate surface, the first texture being formed in a first net-shaped pattern having a first pattern characteristic, the first pattern characteristic having a first predetermined value, and forming a second texture in the substrate surface, the second texture being formed in a second net-shaped pattern having a second pattern characteristic, the second pattern characteristic having a second predetermined value less than the first predetermined value.

The foregoing and/or other aspects of the present general inventive concept may also be achieved by providing a method of texturing a substrate of a magnetic recording disk usable in a disk drive having a magnetic head, the method including texturing a disk substrate with first and second texture patterns including controlling a first difference between first and second surface roughnesses of the first and second texture patterns, and controlling a second difference between first and second line pattern cross angles of the first and second patterns, wherein the controlling the first and second differences increases a fly-abililty of the magnetic head.

The foregoing and/or other aspects of the present general inventive concept may also be achieved by providing a method of operating a disk drive having a magnetic head to read and/or write from or to a textured disk, the method including texturing a substrate of a disk to control a flying height of the magnetic head, including forming a first texture in the substrate surface, the first texture being formed in a first net-shaped pattern having a first pattern characteristic, the first pattern characteristic having a first predetermined value, and forming a second texture in the substrate surface, the second texture being formed in a second net-shaped pattern having a second pattern characteristic, the second pattern characteristic having a second predetermined value less than the first predetermined value, rotating the textured disk, and lifting the magnetic head with a lift force above the rotating disk to a predetermined flying height, the lift force due to air flow generated by the rotation of the textured disk, and reading and/or writing from or to the rotating textured disk.

Additional and/or other aspects and advantages of the present general inventive concept will be set forth in part in the description which follows and, in part, will be obvious from the description, or may be learned by practice of the general inventive concept.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an arrangement between a disk and a magnetic head of a conventional hard disk drive;

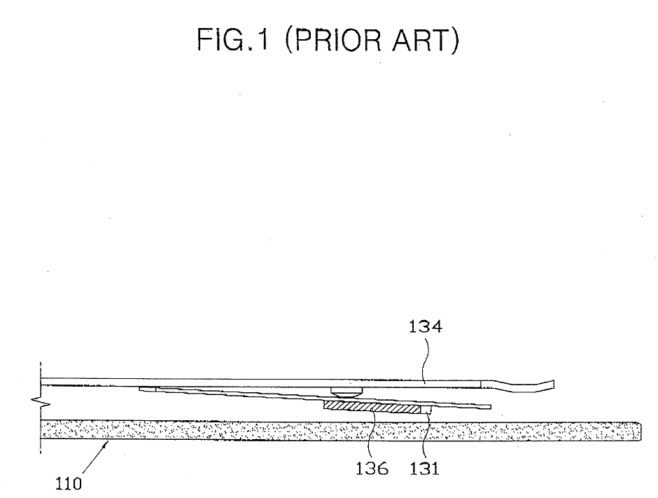

FIG. 2 is a perspective view illustrating a hard disk drive according to an embodiment of the present general inventive concept;

FIG. 3 is a plan view illustrating a disk usable with the hard disk drive of FIG. 2; and

FIG. 4 is a cross-sectional view illustrating the disk of FIG. 3 in which a texture is exaggerated.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

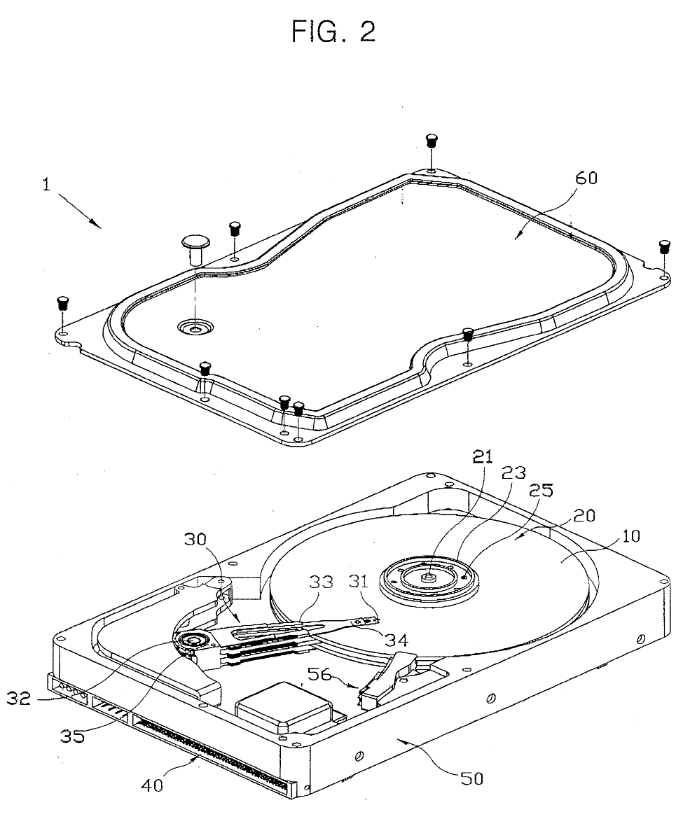

FIG. 2 is a perspective view illustrating a hard disk drive according to an embodiment of the present general inventive concept. Referring to FIG. 2, a hard disk drive (HDD) 1 is a small form factor (SFF) HDD having a diameter of 0.7 to 1.0 inches. The SFF HDD includes a disk pack 20, a head stack assembly (HSA) 30 to read out the data on the disk 10, a printed circuit board assembly (PCBA) 40 having a printed circuit board (PCB) on which most circuit parts, including control parts, are installed, a base 50 on which the above constituent elements are assembled, and a cover 60 to cover an upper portion of the base 50. The disk pack 20 has a disk 10 to record and store data, and various parts to fixedly support and rotate the disk 10.

The disk pack 20 includes a shaft 21 forming a center of rotation of the disk 10, a spindle motor hub (not illustrated) provided outside the shaft 21 in a radial direction to support the disk 10, a clamp 23 coupled to an upper portion of the spindle motor hub, and a clamp screw 25 to fix the disk 10 to the spindle motor hub by pressing the clamp 23.

The HSA 30 is a carriage to record or read data with respect to the disk 10 and includes a magnetic head 31 to record data on the disk 10 or to read the recorded data, an actuator arm 33 to pivot around a pivot shaft 32 above the disk 10 so that the magnetic head 31 can access data on the disk 10, a suspension 34 coupled to an end portion of the actuator arm 33, a pivot shaft holder 35 to rotatably support the pivot shaft 32 and to which the actuator arm 33 is coupled, and a bobbin (not illustrated) provided in a position opposite to the actuator arm 33 from the pivot shaft holder 35 and having a voice coil motor (VCM) coil wound around the bobbin so as to be located between magnets of the VCM (not illustrated). Meanwhile, a ramp 56 to park the magnetic head 31 is at a location away from a recording surface of the disk 10.

The VCM is part of a drive motor allowing the actuator arm 33 to pivot and to move the magnetic head 31 to a desired position on the disk 10. According to Fleming's left-hand rule, when current is applied to the VCM coil located between the magnets, a force is applied to the bobbin so as to move the bobbin. Accordingly, as the actuator arm 33 extends from the pivot shaft holder 35 in a direction opposite to the bobbin pivots, the magnetic head 31 supported at an end of the actuator arm 33 moves radially with respect to the disk 10 that is rotating and searches for and accesses a track having information so that the accessed track information is signal processed.

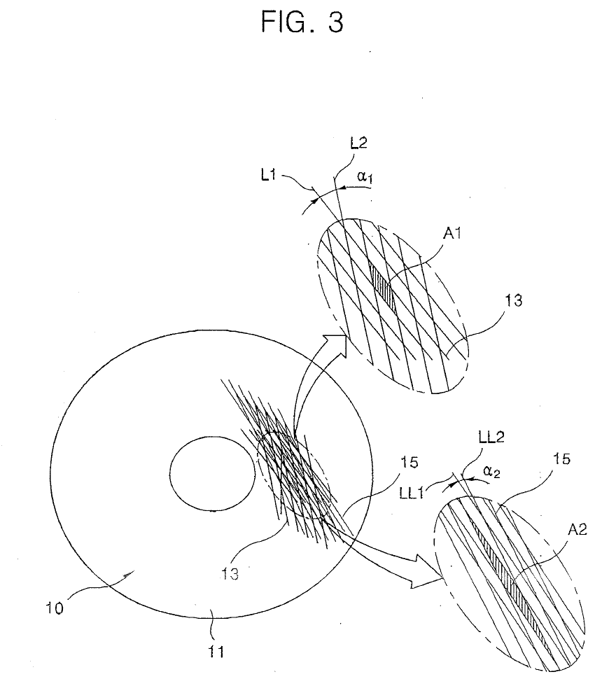

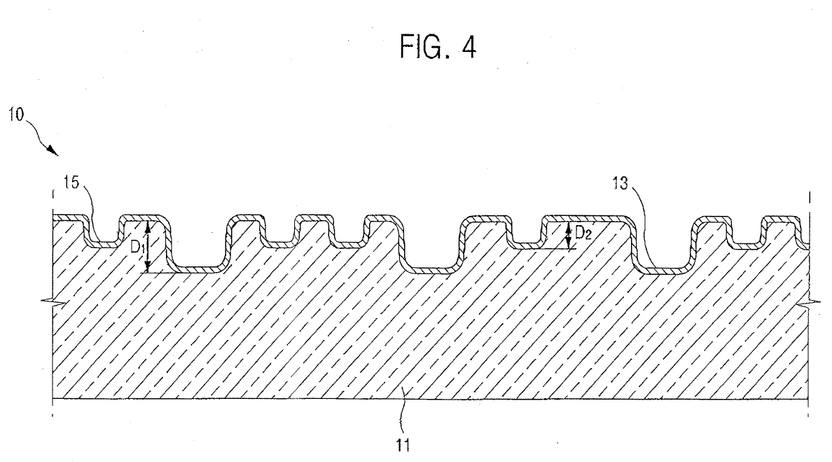

FIG. 3 is a plan view illustrating a disk usable with the hard disk drive of FIG. 2. FIG. 4 is a cross-sectional view of the disk of FIG. 3 in which texture is exaggerated. Referring to FIGS. 3 and 4, a disk 10 usable with an HDD according to an embodiment of the present general inventive concept includes a disk substrate 11, a first texture 13 formed on a surface of the disk substrate 11, and a second texture 15 formed on the surface of the disk substrate 11 independent of the first texture 13. Typically, a magnetic layer, a coating layer, and a lubrication layer (not illustrated) are sequentially formed on the disk substrate 11 textured as described above. Since a variety of methods of forming the magnetic layer, coating layer, and lubrication layer are already widely known, descriptions thereof will be omitted herein and indications of the layers on the drawings will be omitted as well.

The first and second textures 13 and 15 are textured in a direction along a circumference of the disk 10. The texture may be formed in a radial direction. However, when the texture is formed in a radial direction, magnetic performance is deteriorated as compared to a case in which the texture is formed in a circumferential direction so that a capacity to hold data in a track is lowered. Also, when the first texture 13 is textured in the circumferential direction and the second texture 15 is textured in the radial direction, since the types of manufacturing equipment to texture in the circumferential direction and in the radial direction are different from each other, a texturing process is complicated. Also, since dual equipment is needed, manufacturing and installation costs are high. Thus, in the present embodiment, since both first and second textures 13 and 15 are concentrically textured in the circumferential direction with respect to a center of a shaft 21 (refer to FIG. 2), deterioration of magnetic performance can be prevented and the first and second textures can be formed in a simple texturing process.

The first texture 13 is formed recessively in the surface of the disk substrate 11, textured in a first pattern of a first net shape to have a first surface roughness having an average surface roughness of 3-10 Å in the first pattern of the first net shape. The first net shape pattern of the first texture has a first cross angle α1 that is a cross angle where two different circumferential line patterns L1 and L2 cross each other and is relatively large. The first texture 13 is a regular pattern of the first net shape in a circumferential direction with respect to a center of the shaft 21 (refer to FIG. 2) of the disk 10. The first texture creates a relatively deep groove D1 in the surface of the disk 10 as illustrated in FIG. 4.

The first cross angle α1 of the first texture 13 may vary at an inner diameter and an outer diameter of the disk 10, and may be approximately 10° through 30° at the inner diameter of the disk 10. A shape of a particular area of a peak portion encompassed by the grooves is determined by the cross angle. As illustrated in FIG. 3, a particular area A1 of the peak portion between grooves of the first texture 13 having a relatively large cross angle α1 is smaller than a particular area A2 of a peak portion between the grooves of the second texture 15. Accordingly, when the magnetic head 31 contacts the disk 10 while flying over the disk 10, a contact area is decreased. Thus, since excessive absorption and friction generation are decreased, fly-ability of the magnetic head 31 can be improved by the first texture 13. Also, even when the second texture 15 is textured after the first texture 13 has been textured and the magnetic head 31 contacts the disk 10 while flying over the disk 10, a contact area is further decreased so that the fly-ability of the magnetic head 31 is not deteriorated by the second texture 15.

The fly-ability of the magnetic head 31 is related to a roughness of the surface of the disk 10 in addition to the cross angle of the texture. In an embodiment of the present general inventive concept, the average surface roughness of the first texture 13 (e.g., Ra between 3-10 Å) is relatively larger than an average surface roughness of the second texture 15. When the surface roughness of the disk 10 is relatively large, deterioration of the fly-ability of the magnetic head 31 due to a low linear velocity caused by low revolutions per minute (RPMs) can be prevented. This is because a greater amount of air flow can be generated during the rotation of the disk 10 when the surface roughness is great.

The second texture 15 is formed in the surface of the disk substrate 11 independently of the first texture, textured in a second pattern of a second net shape to have a second surface roughness that is relatively smaller than the first surface roughness, and has a second cross angle α2 that is relatively smaller than the first cross angle α1, where α is a cross angle where two different circumferential line patterns LL1 and LL2 cross each other. The second text 15 is textured after the first texture 13 is textured on the disk substrate 11. That is, after the first texture 13 having relatively large surface roughness and cross angle is formed, the second texture 15 having relatively small surface roughness and cross angle is formed. The second texture 15 creates a relatively shallow groove D2 as illustrated in FIG. 4.

The second cross angle α2 of the second texture 15 may be 0-10° at the inner diameter of the disk 10 and may have an average surface roughness Ra between 1-4 Å. When the second cross angle α2 of the second texture 15 is relatively smaller than the first cross angle α1 or the second texture 15 has a small surface roughness, an orientation ratio (OR) that improves a magnetic characteristic (e.g., bit error rate) of the disk 10 is enhanced. Therefore, an improvement of the OR can improve a bit error rate (BER).

For example, when the second cross angle α2 of the second texture 15 is a relatively small cross angle, an orthogonal axis of a grid of cobalt chromium platinum boron (CoCrPtB), that is a cobalt-chromium-based recording layer is well aligned in a groove formed in the second texture 15 so that the OR is improved and thus the BER is improved. Also, when the second texture 15 has a relatively small surface roughness, since the magnetic head 31 is maintained close to the recording surface of the disk 10, the BER can be improved.

CoCrPtB is a cobalt-chromium-based hard disk medium having a longitudinal anisotropy, as opposed to CoPtCrO, which is a cobalt-platinum-based hard disk medium having a perpendicular anisotropy. Although the embodiment described above has been explained by way of example with respect to CoCrPtB having the longitudinal anisotropy, the general inventive concept can also be applied to CoPtCrO or other hard disk media having a perpendicular anisotropy.

With regard to a parallel generation of the first and second textures 13 and 15, even when the first texture 13 is already formed on the disk substrate 11, since the grid of the CoCrPtB that is a cobalt-chromium based recording layer is mainly formed in the second texture 15, the improvement of the OR and BER can be obtained regardless of the existence of the first texture 13. The BER signifies a probability of a binary data formed of 1 and/or 0 converted to an incorrect data on the disk 10, which is one major factor indicating the performance of the HDD. Thus, the improvement of the BER directly effects the performance of the HDD.

Therefore, in the HDD according to the present embodiment described above, since the disk 10 in which the first texture 13 having relatively large surface roughness and cross angle and the second texture 15 having relatively small surface roughness and cross angle are mechanically formed in the circumferential direction of the disk 10, compensation may be made with respect to the deterioration of the fly-ability of the magnetic head 31 which may be generated due to a lower linear velocity caused by a small diameter and a low disk RPM such as 3,600 through 5,400. Simultaneously, the OR of the longitudinal magnetic recording media can be improved.

In the operation of the HDD configured as described above while referring to FIGS. 2 and 3, first, the first texture 13 having the relatively large surface roughness and cross angle can be formed on the disk substrate 11 and then the second texture 15 having the relatively small surface roughness and cross angle can be formed on the disk substrate 11 where the first texture 13 has already been formed. Next, a magnetic layer, a coating layer, and a lubrication layer are sequentially formed on the disk substrate 11 that is textured, to provide the disk 10. By assembling the disk 10 and other parts, the manufacturing of the HDD 1 according to the present embodiment is completed.

Referring to FIG. 2, in a process of the operation of the HDD 1, when power is applied to the HDD 1 to perform recording and reproduction of the data, a lift force due to rotation of the disk 10 and an elastic force created by a suspension 34 are applied to a slider (not illustrated) where a magnetic head 31 is mounted. Accordingly, as the slider maintains a state of floating above a recording surface of the disk 10 at a height where the lift force and the elastic force are balanced, the magnetic head 31 mounted on the slider maintains a predetermined interval from the disk 10 that is rotating while recording and reproducing data with respect to the disk 10.

The HDD 1 according to the present embodiment employs the disk 10 on which the first texture 13 having relatively large surface roughness and cross angle and the second texture 15 having relatively small surface roughness and cross angle are mechanically textured in a circumferential direction of the disk 10, unlike the conventional technology. Thus, a fly-ability of the magnetic head 31 is improved by compensation of deterioration of the fly-ability of the magnetic head 31 caused by a low linear velocity. Simultaneously, the BER can be improved by improving the OR and a magnetic characteristic of the disk 10.

That is, in spite of the fact that a small lift force is applied to the magnetic head 31 due to a low RPM and a small linear velocity caused by a small diameter, by the first texture 13 having relatively large cross angle and surface roughness, even when the magnetic head 31 and the disk 10 contact each other during the operation, since a contact area is relatively small, excessive absorption or friction is prevented so that the fly-ability is improved.

Also, by the second texture 15 having a relatively small cross angle and surface roughness, in spite of the fact that the first texture 13 already exists, an orientation ratio (OR) that improves the magnetic characteristic of the disk 10 is improved and a bit error rate (BER) is improved. In the above embodiment, although the SFF HDD having a diameter of 1 inch or less is described, the technical concept of the present general inventive concept can be applied to an HDD having a diameter of more than 2.5 inches.

As described above, according to the present general inventive concept, the fly-ability of the magnetic head is improved by compensation of the deterioration of the fly-ability of the magnetic head caused by a low linear velocity. Simultaneously, the BER can be improved by improving the OR and the magnetic characteristic of the disk. In addition, the quality of an SFF HDD is improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A disk usable with a hard disk drive comprising:
a first texture recessively formed in a surface of a substrate of the disk and textured in a first pattern of a first net shape, and having a first cross angle where first line patterns of the first pattern cross each other; and
a second texture formed on the surface of the disk substrate independently of the first texture and textured in a second pattern of a second net shape, and a second cross angle where second line patterns of the second pattern cross each other, the second cross angle being relatively smaller than the first cross angle.

2. The disk of claim 1, wherein the second texture is textured after the first texture is textured on the disk substrate.

3. The disk of claim 1, wherein the first texture and the second texture are textured in a circumferential direction.

4. The disk of claim 1, wherein the first cross angle is 10-30° at an inner diameter and the second cross angle is 0-10° at the inner diameter.

5. The disk of claim 1, wherein the first texture has an average surface roughness Ra between 3-10 Å and the second texture has an average surface roughness Ra between 1-4 Å.

6. The disk of claim 1, wherein a diameter of the disk is 0.7-1.0 inch.

7. A disk usable with a hard disk drive comprising:
a first texture recessively formed in a surface of a substrate of the disk and textured in a first pattern of a first net shape to have a first surface roughness; and
a second texture formed on the surface of the disk substrate independently of the first texture and textured in a second pattern of a second net shape to have a second surface roughness that is relatively smaller than the first surface roughness.

8. The disk of claim 7, wherein the second texture is textured after the first texture is textured on the disk substrate.

9. The disk of claim 7, wherein the first texture and the second texture are textured in a circumferential direction.

10. The disk of claim 7, wherein the first texture has an average surface roughness Ra between 3-10 Å and the second texture has an average surface roughness Ra between 1-4 Å.

11. A hard disk drive comprising:
a base; and
a disk installed on the base, the disk comprising:
a first texture recessively formed in a surface of a substrate of the disk and textured in a first pattern of a first net shape, and having a first cross angle where first line patterns of the first pattern cross each other; and
a second texture formed on the surface of the disk substrate independently of the first texture and textured in a second pattern of a second net shape, and a second cross angle where second line patterns of the second pattern cross each other, the second cross angle being relatively smaller than the first cross angle.

12. The hard disk drive of claim 11, wherein the second texture is textured after the first texture is textured on the disk substrate.

13. The hard disk drive of claim 11, wherein the first texture and the second texture are textured in a circumferential direction.

14. The hard disk drive of claim 11, wherein the first cross angle is 10-30° at an inner diameter and the second cross angle is 0-10° at the inner diameter.

15. The hard disk drive of claim 11, wherein the first texture has an average surface roughness Ra between 3-10 Å and the second texture has an average surface roughness Ra between 1-4 Å.

16. The hard disk drive of claim 11, wherein a diameter of the disk is 0.7-1.0 inch.

17. A hard disk drive comprising:
a base; and
a disk installed on the base, the disk comprising:
a first texture recessively formed in a surface of a substrate of the disk and textured in a first pattern of a first net shape to have a first surface roughness; and
a second texture formed on the surface of the disk substrate independently of the first texture and textured in a second pattern of a second net shape to have a second surface roughness that is relatively smaller than the first surface roughness.

18. The hard disk drive of claim 17, wherein the second texture is textured after the first texture is textured on the disk substrate.

19. The hard disk drive of claim 17, wherein the first texture and the second texture are textured in a circumferential direction.

20. The hard disk drive of claim 17, wherein the first texture has an average surface roughness Ra between 3-10 Å and the second texture has an average surface roughness Ra between 1-4 Å.

21. A disk usable with a hard disk drive, comprising:
first patterns formed thereon along a surface of the disk; and
second patterns formed thereon along the surface of the disk different from the first patterns.

22. The disk of claim 21, wherein the first patterns include line patterns having a first cross angle and the second patterns include line patterns having a second cross angle less than the first cross angle.

23. The disk of claim 21, wherein a roughness of the first patterns is greater than a roughness of the second patterns.

24. A method of texturing a recordable medium formed of a substrate, the method comprising:
forming a first texture in a substrate surface, the first texture being formed in a first net-shaped pattern having a first pattern characteristic, the first pattern characteristic having a first predetermined value; and
forming a second texture in the substrate surface, the second texture being formed in a second net-shaped pattern having a second pattern characteristic, the second pattern characteristic having a second predetermined value less than the first predetermined value.

25. The texturing method of claim 24, wherein the recordable medium is a disk usable in a small form factor hard disk drive.

26. The texturing method of claim 24, wherein the first pattern characteristic comprises an angle formed between crossing line patterns of the first net-shaped pattern, and the second pattern characteristic comprises an angle formed between crossing line patterns of the second net-shaped pattern.

27. The texturing method of claim 26, wherein the first pattern characteristic of the first net-shaped pattern further comprises a first surface roughness, and the second pattern characteristic of the second net-shaped pattern further comprises a second surface roughness.

28. The texturing method of claim 24, wherein the first and second textures are formed concentrically in a circumferential direction.

29. A method of texturing a substrate of a magnetic recording disk usable in a disk drive having a magnetic head, the method comprising:
texturing a disk substrate with first and second texture patterns, the texturing the disk substrate comprising:
controlling a first difference between first and second surface roughnesses of the first and second texture patterns, and
controlling a second difference between first and second line pattern cross angles of the first and second patterns;
wherein the controlling the first and second differences increases a fly-ability of the magnetic head.

30. A method of operating a disk drive having a magnetic head to read and/or write from or to a textured disk, the method comprising:
texturing a substrate of a disk to control a flying height of the magnetic head, comprising:
forming a first texture in a substrate surface, the first texture being formed in a first net-shaped pattern having a first pattern characteristic, the first pattern characteristic having a first predetermined value, and
forming a second texture in the substrate surface, the second texture being formed in a second net-shaped pattern having a second pattern characteristic, the second pattern characteristic having a second predetermined value less than the first predetermined value;
rotating the textured disk; and
lifting the magnetic head with a lift force above the rotating disk to a predetermined flying height, the lift force due to air flow generated by the rotation of the textured disk; and
reading and/or writing from or to the rotating textured disk.
